(19) United States
(12) Patent Application Publication
(10) Pub. No.: US 2010/0274774 A1
(43) Pub. Date: Oct. 28, 2010

(54) DIGITAL DATA TAGGING APPARATUS, SYSTEM AND METHOD FOR PROVIDING TAGGING AND SEARCH SERVICE USING SENSORY AND ENVIRONMENTAL INFORMATION

(75) Inventors: Ji Yeon Son, Daejeon (JP); Jae Seon Lee, Seoul (KR); Yong Hee Lee, Daejeon (KR); Hee Sook Shin, Daejeon (KR); Jun Young Lee, Daejeon (KR); Ji Geun Lee, Jeollabuk-do (KR); Ki Uk Kyung, Daejeon (KR); Jun Seok Park, Daejeon (KR); Chang Seok Bae, Daejeon (KR)

Correspondence Address: AMPACC Law Group, 3500 188th Street S.W., Suite 103, Lynnwood, WA, 98037, US

(73) Assignee: Electronics and Telecommunications Research Institute, Daejeon (KR)

(21) Appl. No.: 12/747,157

(22) PCT Filed: May 30, 2008
(86) PCT No.: PCT/KR08/03047

§ 371 Date: Jun. 9, 2010

(30) Foreign Application Priority Data
Dec. 10, 2007 (KR) 10-2007-0127876

(51) Int. Cl. G06F 17/30

(52) U.S. Cl. 707/706; 707/736; 707/E17.044; 707/802; 707/E17.108; 707/803

(57) ABSTRACT

Provided are a digital data tagging apparatus for generating sensory and environmental information as a tag and endowing digital data with the sensory and environmental information that is automatically extracted using sensory sensor data and environmental sensor data, all of which are sensed by humans through their sensory organs, and a system and method for providing a tagging and search service using sensory and environmental information. The digital data tagging apparatus, and the system and method for providing a tagging and search service may be useful to enable users to search and use digital data more effectively and abundantly through the later use of the sensory and environmental information by collectively recognizing sensory and environmental information and automatically or manually endowing digital data with the recognized sensory and environmental information as a tag, wherein the sensory and environmental information are sensed by humans through their sensory sensors such as an olfactory sensor, a taste sensor and a tactile sensor; an environmental sensor such as temperature, humidity, illumination intensity and wind speed sensors, etc., as well as a camera or a mic.

### TECHNICAL FIELD

The present invention relates to a digital data tagging apparatus for endowing digital data with sensory and environmental information as a tag, the sensory and environmental information being sensed by humans through their sensory organs, and a system and method for providing a tagging and search service using sensory and environmental information, and more particularly, to a digital data tagging apparatus for automatically or manually endowing digital data with sensory and environmental information as a tag, the sensory and environmental information being sensed by humans and collected through a sensory sensor such as an electronic nose (an olfactory sensor), an electronic tongue (a taste sensor) and a tactile sensor; an environmental sensor such as temperature, humidity, illumination intensity and wind speed sensors, etc., and a system and method for providing a tagging and search service using sensory and environmental information.

This work was supported by the IT R&D Program of MIC/IITA [2006-S-032-02, Development of an Intelligent Service Technology Based on the Personal Life Log].

### BACKGROUND ART

In general, the tagging of digital data has been widely known as one of techniques for classifying and collectively managing data by using information on time, space, people and things as a tag.

Here, the tag is a metadata that is attached to digital data to access and search data more swiftly. The metadata have been used to search and find data from a computer more rapidly.

Therefore, this tag information such as the metadata has been mainly divided into a tag for space, a tag for people, a tag for things, a tag for time, etc. In this case, image analyses and bar codes, radio frequency identification (RFID), etc. have been used to extract the tag information from the digital data.

In order to effectively find desired information from a large quantity of information and employ the desired information, the metadata is conferred on the digital data, e.g., contents, according to the predetermined rules. The rules cover the location and details of the contents, information on writers, rights terms, conditions for use, use cases, etc.

Therefore, the metadata functions as an index of information. Data may be easily and quickly found from the widely used databases since the metadata has been well-composed in the databases. Also, users can use the metadata to easily find certain data (information) using a search engine, etc.

However, the problem is that it is impossible to support a method for accessing or searching digital data from sensory and environmental information including information on emotional state, bio-information, or environmental information such as weather at the point of time when the digital data is generated, etc.

### DISCLOSURE OF INVENTION

### Technical Problem

The present invention is designed to solve the problems of the prior art, and therefore it is an object of the present invention to provide a digital data tagging apparatus for tagging digital data using sensory and environmental information as a tag, the sensory and environmental information being sensed by humans through their sensory organs, and a system and method for providing a tagging and search service.

### Technical Solution

According to an aspect of the present invention, there is provided a digital data tagging apparatus using sensory and environmental information, the digital data tagging apparatus including a data analysis module collecting and analyzing digital data and sensor data; a sense recognition module extracting sensory and environmental information from the analysis results; and a metadata generation module generating a metadata by endowing digital data with the extracted sensory and environmental information as a tag.

Here, the digital data tagging apparatus may further include a database storing the digital data and the metadata including the sensory and environmental information.

According to another aspect of the present invention, there is provided an apparatus for providing a tagging and search service using sensory and environmental information, the digital data tagging apparatus including a metadata generation module generating a metadata by endowing digital data with sensory and environmental information as a tag; an application service module transferring a search request for the digital data using the sensory and environmental information; and a search engine searching digital data through the metadata according to the transferred search request, the digital data using the sensory and environmental information as a tag.

Here, the apparatus may further include a data analysis module collecting sensor data from sensors and digital data and analyzing the collected sensor data to extract the sensory and environmental information; and a sense recognition module extracting sensory and environmental information from the analysis results and transferring the extracted sensory and environmental information to the metadata generation module.

Also, the apparatus may further include a database storing the digital data and the metadata including the sensory and environmental information.

According to still another aspect of the present invention, there is provided a system for providing a tagging and search service using sensory and environmental information, the system including a sensing device composed of a plurality of sensors to output sensor data and digital data, the sensor data including at least one selected from the group consisting of sensory sensor data, position sensor data and environmental sensor data; a user terminal collecting the sensor data; and a tagging and search providing server for analyzing the sensor data to extract sensory and environmental information and generating a metadata by endowing the digital data with the sensory and environmental information as a tag.

Here, the tagging and search providing server may generate a database schema and stores the generated metadata to correspond to the architecture of the database schema.

Also, the tagging and search providing server may further include a metadata generation module endowing the digital data with the sensory and environmental information as a tag and generating a metadata including the sensory and environmental information; an application service module transferring a search request for the digital data using the sensory and environmental information; and a search engine searching digital data through the metadata according to the transferred search request, the digital data using the sensory and environmental information as a tag.

In addition, the tagging and search providing server may further include a database storing the digital data and the metadata.

Furthermore, the tagging and search providing server may further include a data analysis module analyzing the sensor data to extract the sensory and environmental information; and a sense recognition module extracting sensory and environmental information from the analysis results and transferring the extracted sensory and environmental information to the metadata generation module.

According to yet another aspect of the present invention, there is provided a method for providing a tagging and search service using sensory and environmental information, the method including: collecting and interpreting sensor data and digital data; recognizing sensory and environmental information by analyzing the interpreted data; endowing the digital data with the recognized sensory and environmental information as a tag; generating a metadata including the sensory and environmental information and storing the generated metadata; and searching digital data using the stored sensory and environmental information.

Here, the sensor data may include at least one selected from the group consisting of sensory sensor data including a visual sense, an auditory sense, a tactile sense, an olfactory sense and a taste sense; environmental sensor data including temperature, humidity and illumination intensity; and position sensor data.

Also, the sensory and environmental information may include at least one selected from the group consisting of an emotional state (including delight, astonishment, fear, dislike and anger), a stress index, a sensible temperature and a comfort index.

### ADVANTAGEOUS EFFECTS

The digital data tagging apparatus, and the system and method for providing a tagging and search service according to the present invention may be useful to enable users to access and search digital data in a more effective and human-friendly manner by endowing the digital data with sensory and environmental information as a tag, the sensory and environmental information being sensed by humans through their sensory organs.

### BRIEF DESCRIPTION OF THE DRAWINGS

The above and other aspects, features and other advantages of the present invention will be more clearly understood from the following detailed description taken in conjunction with the accompanying drawings.

FIG. 1 is a block view illustrating a system for automatically endowing digital data with sensory and environmental information as a tag and searching digital data using the sensory and environmental information according to one exemplary embodiment of the present invention.

FIG. 2 is a schematic block view illustrating a user terminal and a tagging and search providing server according to one exemplary embodiment of the present invention.

FIG. 3 is a schematic block view illustrating a user terminal and a tagging and search providing server according to another exemplary embodiment of the present invention.

FIG. 4 is a flowchart illustrating an operation of automatically tagging and searching sensory and environmental information as shown in FIG. 2.

FIG. 5 is a flowchart illustrating an operation of automatically tagging and searching sensory and environmental information as shown in FIG. 3.

### BEST MODE FOR CARRYING OUT THE INVENTION

Hereinafter, exemplary embodiments of the present invention will now be described in detail with reference to the accompanying drawings. Therefore, it is considered that the present invention may be easily devised as apparent to those skilled in the art to which the present invention belongs.

For the detailed description of the present invention, it is considered that descriptions of known components and their related configurations according to the exemplary embodiments of the present invention may be omitted since they are judged to make the gist of the present invention unclear.

Also, it is considered that parts that have the similar or substantially identical functions and effects in the accompanying drawings have the same reference numerals.

In addition, when it is considered that one part is “connected to” another part(s) throughout the specification, this does not mean only a case of “directly connected to” but also a case of “indirectly connected to” while interposing another device(s) therebetween.

Also, it is considered that to “includes” one element means that the apparatus does not exclude other elements but may further include other elements, unless otherwise particularly indicated.

Also, the term ‘module’ means one unit for performing certain functions operations. Here, the module may be realized in hardware, software, or a combination of the hardware and the software.

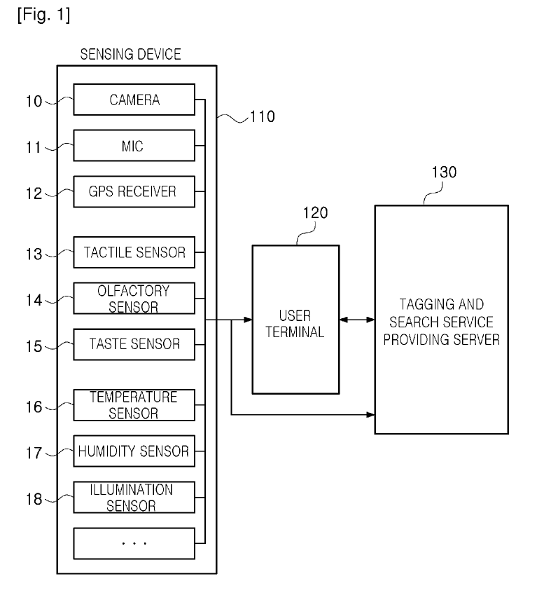

FIG. 1 shows a system for automatically endowing digital data with sensory and environmental information as a tag and searching digital data using the sensory and environmental information according to one exemplary embodiment of the present invention.

Referring to FIG. 1, the system according to one exemplary embodiment of the present invention includes a sensing device 110, a user terminal 120 and a tagging and search providing server 130.

The sensing device 110 is an assembly of at least one sensor device that is necessary to collect sensory and environmental information, and includes sensory sensors 13 to 15 such as a visual sensor, an auditory sensor, a tactile sensor, an olfactory sensor (electronic nose) and a taste sensor (electronic tongue); environmental sensors 16 to 18 such as temperature, humidity and illumination intensity sensors; a position sensor and inertial sensors; a camera 10, a mic 11 and a GPS receiver 12.

The sensing device 110 transmits sensor data, which are sensed by the sensors, to a user terminal 120 that is connected to the sensing device 110 in a wire or local-area wireless communication mode. Also, the sensing device 110 transmits image and sound data (hereinafter, referred to as ‘digital data’), which are generated through the camera 10 and the mic 11, to the tagging and search providing server 130.

Here, the sensing device 110 may transmit the digital data to the user terminal 120 as in the sensor data without directly transmitting the digital data to the tagging and search providing server 130.

The sensor data will be described in detail in the present invention, but description of the digital data is omitted since its operation is identical to that of the sensor data.

The user terminal 120 may give access to internets through the wire or local-area wireless communication with the sensing device 110 and the tagging and search providing server 130, and includes notebook computers, small personal computers (PC) such as PDA, mobile terminals, etc.

The user terminal 120 collects sensor data from the sensing device 110 and transmits data, which are interpreted as useful information using the collected sensor data or some of the collected sensor data, to the tagging and search providing server 130.

For example, the user terminal 120 calculates a sensible temperature using the collected sensor data about temperature and humidity, and then transmits information on the calculated sensible temperature to the tagging and search providing server 130.

The tagging and search providing server 130 automatically extracts sensory and environmental information from the sensor data transmitted from the user terminal 120. And, the tagging and search providing server 130 functions to endow a digital data with the sensory and environmental information as a tag, generate a metadata including the sensory and environmental information and store the generated metadata in a database.

Also, the tagging and search providing server 130 executes a search feature such as a web-based digital data search service or a recall service for past personal records. As described above, the tagging and search providing server 130 supports the data storage and search function.

For example, the tagging and search providing server 130 executes a function to access and search digital data through the past sensory and environmental information such as ‘the last summer when it was hottest’, ‘the year when it snowed hardest in my life’, ‘the day when I cried most in my life’, ‘lilac smell’, etc.

Meanwhile, the sensory and environmental information may be manually inputted through the user terminal 120 in the present invention. Also, a user may directly input the sensory and environmental information to give a tag for digital data. Description of the direct input system is omitted in the present invention.

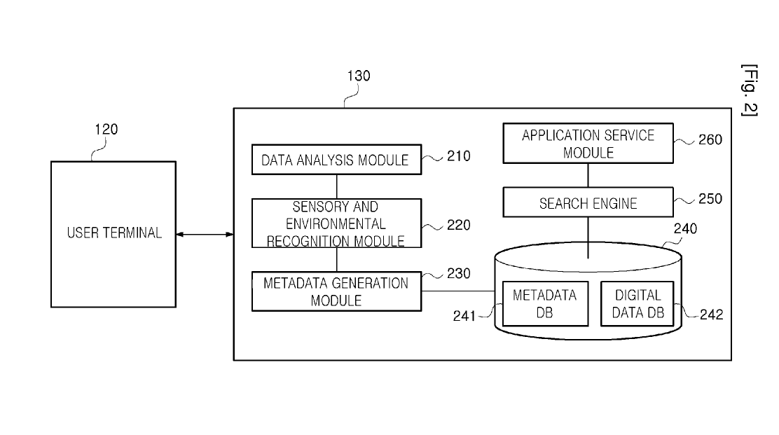

The configuration of the tagging and search providing server 130 according to one exemplary embodiment of the present invention will be described in detail with reference to FIG. 2.

FIG. 2 shows a schematic configuration of the tagging and search providing server 130 as shown in FIG. 1. Here, the tagging and search providing server 130 includes a data analysis module 210, a sensory and environmental information recognition module 220, a metadata generation module 230, a database 240, a search engine 250 and an application service module 260.

The data analysis module 210 functions to analyze the sensory sensor data (e.g., a tactile sense, an olfactory sense and a taste sense) and the location or environmental sensor data transmitted from the user terminal 120, or the digital data transmitted from the sensing device 110. That is to say, the data analysis module 210 automatically makes analyses of images, sounds and environmental changes for the transmitted data.

The sensory and environmental information recognition module 220 functions to recognize the sensory and environmental information at the point of time when the digital data are generated on the basis of the data analyzed in the data analysis module 210.

For example, the sensory and environmental information recognition module 220 recognizes the sensory and environmental information on weather, emotional state and sensation, such as ‘when it was hottest’, ‘when it snowed hardest in my life’, ‘when I cried most in my life’, ‘lilac smell’, etc., at the point of time when the digital data are generated.

The metadata generation module 230 endows digital data with the sensory and environmental information as a tag and automatically generates a metadata including the recognized sensory and environmental information. The metadata generation module 230 stores the generated metadata in the database 240.

The database 240 is composed of a metadata DB 241 and a digital data DB 242, and the digital data transmitted from the sensing device 110 and the generated metadata are stored in the database 240 at the same time.

The stored digital data and metadata is searched and managed through the search engine 250 by the application service module 260.

As another alternative, the digital data tagging apparatus may be configured so that the user terminal 120 can include the data analysis module 210 and the sensory and environmental information recognition module 220 that are provided in the tagging and search providing server 130, as shown in FIG. 2B. Therefore, the digital data tagging apparatus may be realized in various configurations, but there is no particular limitation on the methods and mode for configuration of the digital data tagging apparatus.

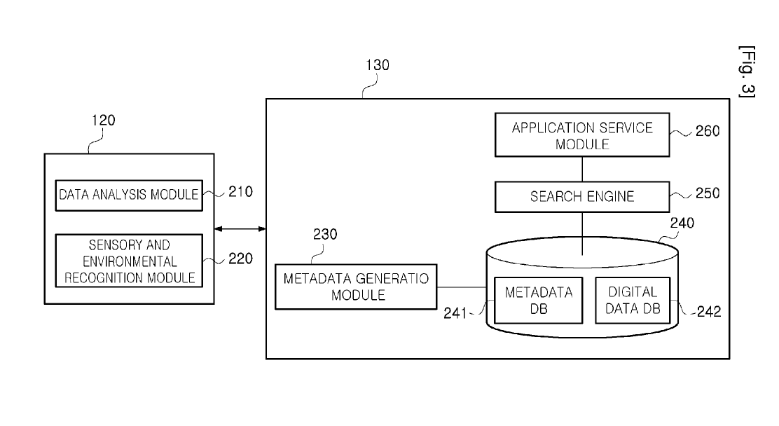

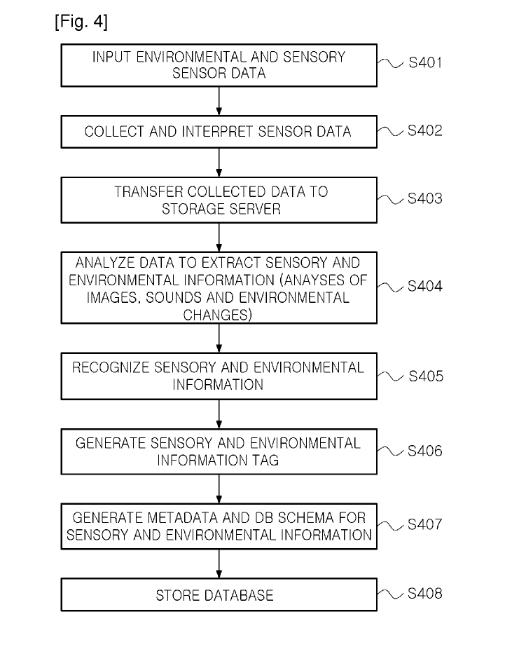

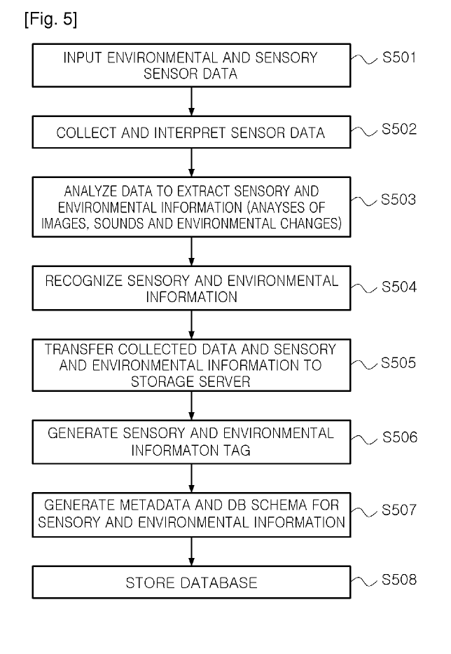

Referring to FIG. 3, when the user terminal 120 includes the data analysis module 210 or the sensory and environmental information recognition module 220, the data transmitted to the tagging and search providing server 130 is not data interpreted from the sensor data but sensory and environmental information extracted from the interpreted data. A tagging operation as configured thus will be described in detail with reference to FIGS. 4 and 5.

Then, a method will be described in detail with reference to FIGS. 4 and 5, including; collecting data from sensory and environmental sensors according to the configuration of the user terminal 120 and the tagging and search providing server 130, automatically endowing the digital data with the sensory and environmental information as a tag and searching desired digital data using the sensory and environmental information.

FIGS. 4 and 5 are flowcharts illustrating a method for collecting data from sensory and environmental sensors according to the configuration of the user terminal 120 and the tagging and search providing server 130 and automatically tagging the sensory and environmental information.

Herein, FIG. 4 shows one exemplary embodiment where the data analysis module 210 and the sensory and environmental information recognition module 220 are arranged in the tagging and search providing server 130, and FIG. 5 shown one exemplary embodiment where the data analysis module 210 and the sensory and environmental information recognition module 220 are arranged in the user terminal 120.

Referring to FIG. 4, when sensor data are first inputted from the sensing device 110 including at least one sensory and environmental sensor (S401), the user terminal 120 collects and interprets sensor data (S402).

And, the collected sensor data are transmitted from the user terminal 120 to the tagging and search providing server 130 when the sensor data satisfy certain requirements that are periodically set, or set by users or on request of the users (S403).

Then, the tagging and search providing server 130 analyzes data values of the transmitted sensor data and extracts sensory and environmental information from the transmitted sensor data (S404). In this case, the tagging and search providing server 130 collectively analyzes time and location information, image and sound information, and environmental information such as temperature, humidity and illumination intensity so as to enhance accuracy of the extraction of the sensory and environmental information.

The sensory and environmental information is automatically extracted on the basis of the sensor data analysis results (S405). One exemplary embodiment of the sensory and environmental information may include emotional state (represented by delight, sorrow, astonishment, fear, dislike and anger), sensible temperature, comfort index, stress index, etc.

Digital data are endowed with the extracted sensory and environmental information as a tag (S406), and a metadata (including the sensory and environmental information used as a tag) and a database schema are generated (S407), and the metadata is stored in the database to correspond to the architecture of the database schema (S408).

Also referring to FIG. 5, when the sensed sensor data are first inputted from the sensing device 110 including at least one sensory and environmental sensor (S501), the user terminal 120 collects and interprets sensor data (S502).

Then, the user terminal 120 analyzes data values of the collected sensor data to extract sensory and environmental information from the collected sensor data (S503). In this case, this operation includes: collectively analyzing location information, image and sound information, and environmental information such as temperature, humidity and illumination intensity so as to enhance accuracy of the extraction of the sensory and environmental information.

The sensory and environmental information is automatically extracted on the basis of these data analysis results (S504). One exemplary embodiment of the sensory and environmental information may include emotional state (represented by delight, sorrow, astonishment, fear, dislike and anger), sensible temperature, comfort index, sensation (e.g., smell, taste and feeling), stress index, etc.

The collected sensor data and the extracted sensory and environmental information are transmitted to the tagging and search providing server 130 when they satisfy certain requirements that are periodically set, or set by users or on request of the users (S505).

Digital data are endowed with the extracted sensory and environmental information as a tag (S506), and a metadata (including the sensory and environmental information used as a tag) and a database schema are generated (S507), and the metadata is stored in the database to correspond to the architecture of the database schema (S508).

While the present invention has been shown and described in connection with the exemplary embodiments, it will be apparent to those skilled in the art that modifications and variations can be made without departing from the spirit and scope of the invention as defined by the appended claims.

1. A digital data tagging apparatus using sensory and environmental information, the digital data tagging apparatus comprising:
a data analysis module collecting and analyzing digital data and sensor data;
a sense recognition module extracting sensory and environmental information from the analysis results; and
a metadata generation module generating a metadata by endowing digital data with the extracted sensory and environmental information as a tag.

2. The digital data tagging apparatus of claim 1, further comprising a database storing the digital data and the metadata.

3. The digital data tagging apparatus of claim 1, wherein the data analysis module analyzes sensory information, environmental information including temperature, humidity and illumination intensity, location information and image and sound information from the collected sensor data.

4. The digital data tagging apparatus of claim 1, wherein the sensor data includes at least one selected from the group consisting of sensory sensor data including a visual sense, an auditory sense, a tactile sense, an olfactory sense and a taste sense; environmental sensor data including temperature, humidity and illumination intensity; position sensor data; and inertial sensor data.

5. The digital data tagging apparatus of claim 1, wherein the sensory and environmental information includes at least one selected from the group consisting of an emotional state, a stress index, a sensible temperature and a comfort index.

6. An apparatus for providing a tagging and search service using sensory and environmental information, the apparatus comprising:
a metadata generation module generating a metadata by endowing digital data with sensory and environmental information as a tag;
an application service module transferring a search request for the digital data using the sensory and environmental information; and
a search engine searching digital data through the metadata according to the transferred search request, the digital data using the sensory and environmental information as a tag.

7. The apparatus of claim 6, further comprising:
a data analysis module collecting sensor data from sensors and digital data and analyzing the collected sensor data to extract the sensory and environmental information; and
a sense recognition module extracting sensory and environmental information from the analysis results and transferring the extracted sensory and environmental information to the metadata generation module.

8. The apparatus of claim 7, wherein the sensor data includes at least one selected from the group consisting of sensory sensor data including a visual sense, an auditory sense, a tactile sense, an olfactory sense and a taste sense; environmental sensor data including temperature, humidity and illumination intensity; and position sensor data.

9. The apparatus of claim 6, further comprising a database storing a metadata including the digital data and the sensory and environmental information.

10. The apparatus of claim 6, wherein the sensory and environmental information includes at least one selected from the group consisting of an emotional state, a stress index, a sensible temperature and a comfort index.

11. A system for providing a tagging and search service using sensory and environmental information, the system comprising:
a sensing device composed of a plurality of sensors to output sensor data and digital data, the sensor data including at least one selected from the group consisting of sensory sensor data, position sensor data and environmental sensor data;
a user terminal collecting the sensor data; and
a tagging and search providing server analyzing the sensor data to extract sensory and environmental information and generating a metadata by endowing the digital data with the sensory and environmental information as a tag.

12. The system of claim 11, wherein the sensory and environmental information includes at least one selected from the group consisting of an emotional state, a stress index, a sensible temperature and a comfort index.

13. The system of claim 11, wherein the sensing device comprises at least one selected from the group consisting of: a sensory sensor including at least one selected from the group consisting of a visual sensor, an auditory sensor, a tactile sensor, an olfactory sensor and a taste sensor; an environmental sensor including at least one selected from the group consisting of temperature, humidity, wind speed and illumination intensity sensors; a position sensor; and an inertial sensor.

14. The system of claim 11, wherein the tagging and search providing server generates a database schema and stores the metadata to correspond to the architecture of the database schema.

15. The system of claim 11, wherein the tagging and search providing server comprises:
a metadata generation module endowing the digital data with the sensory and environmental information as a tag and generating a metadata including the sensory and environmental information;
an application service module transferring a search request for the digital data using the sensory and environmental information; and
a search engine searching digital data through the metadata according to the transferred search request, the digital data using the sensory and environmental information as a tag.

16. The system of claim 15, wherein the tagging and search providing server further comprises a database storing the digital data and the metadata.

17. The system of claim 15, wherein the tagging and search providing server further comprises:
a data analysis module analyzing the sensor data to extract the sensory and environmental information; and
a sense recognition module extracting sensory and environmental information from the analysis results and transferring the extracted sensory and environmental information to the metadata generation module.

18. The system of claim 15, wherein the user terminal further comprises:
a data analysis module analyzing the sensor data collected from the sensors to extract the sensory and environmental information; and
a sense recognition module extracting sensory and environmental information from the analysis results and transferring the extracted sensory and environmental information to the metadata generation module.

19. A method for providing a tagging and search service using sensory and environmental information, the method comprising:
collecting and interpreting sensor data and digital data;
recognizing sensory and environmental information by analyzing the interpreted data;
endowing the digital data with the recognized sensory and environmental information as a tag;
generating a metadata including the sensory and environmental information and storing the generated metadata; and
searching digital data using the stored sensory and environmental information.

20. The method of claim 19, wherein the sensory and environmental information includes at least one selected from the group consisting of an emotional state, a stress index, a sensible temperature and a comfort index.

21. The method of claim 19, wherein the sensor data includes at least one selected from the group consisting of sensory sensor data including a visual sense, an auditory sense, a tactile sense, an olfactory sense and a taste sense; environmental sensor data including temperature, humidity and illumination intensity; and position sensor data.
